(19) United States
(12) Patent Application Publication
(10) Pub. No.: US 2005/0174035 A1
(43) Pub. Date: Aug. 11, 2005

(54) Deflection yoke for correcting misconvergence

(76) Inventors: Seok-Hwan Hwang, Kyunggi-do (KR); Sang-Ho Shin, Kyunggi-do (KR); Sung-Woo Kim, Kyunggi-do (KR)

Correspondence Address: GOTTLIEB RACKMAN & REISMAN PC, 270 MADISON AVENUE, 8TH FLOOR, NEW YORK, NY, 100160601, US

(21) Appl. No.: 10/849,655

(22) Filed: May 20, 2004

(30) Foreign Application Priority Data
Feb. 5, 2004 (KR) 2004-7582

(51) Int. Cl. H01J 29/70

(52) U.S. Cl. 313/440

(57) ABSTRACT

A deflection yoke includes a vertical deflection coil part and first and second pairs of coils that are symmetrically disposed around a portion of the vertical deflection coil part. Winding directions of the first pair of coils are opposite to those of the second pair of coils, thereby compensating for the misconvergence incurred when light spot is vertically displaced.

### BACKGROUND OF THE INVENTION

1. Field of the Invention

The present invention relates to a deflection yoke for correcting misconvergence, and more particularly, to a deflection yoke for correcting misconvergence, which is caused by a light spot displacement in a vertical direction, using first and second pairs of symmetrically disposed coils, winding directions of the first pair of coils being opposite to those of the second pair of coils.

2. Description of the Related Art

Generally, a cathode ray tube (CRT) used in a television set or a display monitor uses a deflection yoke. The deflection yoke is mounted around a neck of the CRT, being comprised of a pair of vertical deflection coils and a pair of horizontal deflection coils. When sawtooth current is applied to the coils, the deflection yoke generates the magnetic field. The magnetic field deflects electron beams emitted from an electron gun of the CRT in horizontal and vertical directions, thereby allowing the electron beams to reach an anode screen through apertures of a mask.

In the television set or the display monitor, electron beams emitted from the electron gun is deflected to displace light spot. This is realized by the deflection yoke.

The deflection method for displacing the light spot can be classified into an electric field deflection method used in an oscilloscope and a magnetic field deflection method used in the television set or the display monitor.

The electric field deflection method is configured to displace the light spot using a property that identical electric charges repel each other and different electron charges attract each other.

The magnetic field is configured to displace the light spot by changing an advancing direction of electron beams using a uniform magnetic field generated by a coil disposed around an electron beam path. This follows Fleming's left-hand rule where, when a wire carrying an electric current is moved in a magnetic field of a magnet, the magnetic field induced by the wire reacts with the magnetic field of the magnet, causing the wire to move outwards.

Describing more in detail on the magnetic field deflection in an actual CRT, the electron beam emitted from the electron gun are advanced while being accelerated (at this point, the current flows in an opposite direction). Therefore, the current flows as if there is a conductor, and the light spot is displaced as the advancing direction of the electron beam is changed by magnetic flux of the deflection coil.

Deflection force is proportional to intensity of the magnetic field. Therefore, when the intensity of the magnetic field is enhanced, the deflection force is increased, thereby increasing the displacement distance of the light spot. That is, the intensity of the magnetic field can be varied by varying an amount of current flowing along the deflection coils, thereby varying the displacement distance of the light-spot.

To displace the light spot, the deflection yoke is provided with two pairs of coils disposed such that vertical and horizontal magnetic fields can be uniformly generated. When current is appropriately applied to the coils, vertical and horizontal scans can be simultaneously realized. At this point, the coil for displaying the light spot in the vertical direction is called a horizontal deflection coil (H-coil) while the coil for displacing the light spot in the horizontal direction is called a vertical deflection coil (V-coil).

These deflection coils are installed in the deflection yoke, and the vertical deflection coils is shown in FIG. 1.

FIG. 1 shows a circuit diagram of a vertical deflection coil mounted on the deflection yoke.

As shown in FIG. 1, a vertical deflection coil includes a coil L1, a loop LP1 having a variable resistor VR1 and a resistor R1, a coil L2, and a loop LP2 having a variable resistor VR1 and a resistor R2.

FIG. 2 shows a sectional view of the vertical deflection coil part of the deflection yoke.

As shown in FIG. 2, the coils L1 and L2 generate respective barrel magnetic fields. A direction of the barrel magnetic fields is determined in accordance with the Fleming's left hand rule. That is, the barrel magnetic fields are formed when sawtooth current supplied from an outer power source flow along the coils L1 and L2. The barrel magnetic fields are formed in a direction vertical to a direction where the current flows along the coils L1 and L2. A force F for displacing the light spot of the electron beam is determined by the barrel magnetic barrels and the direction of the current inputted.

Therefore, the light spot is scanned by the vertical deflection coil part as shown in FIG. 3a. At this point, a convergence property of red R and blue B pixels distorted with reference to green G pixels is shown in FIG. 3b.

That is, FIG. 3b shows a convergence property incurred when the light spot is scanned on a screen by the vertical deflection coil part.

As shown in the drawing, the green G pixels are arranged on X and Y axes at a predetermined interval. That is, five green G pixels are positioned on points x1-x5 that are arranged in a direction of the X-axis at a predetermined interval. Five green G pixels are further positioned in a direction of the Y-axis at a predetermined interval.

For example, a green G pixel is position on a point (x1, y1), a green G pixel is located on a point (x1, y5), a green G pixel is position on a point (x5, y1), and a green G pixel is located on a point (x5, y5). At this point, distances between the points are identical to each other.

As described above, a distortion property of the red R and blue B pixels with reference to the green G pixels arranged on the X and Y-axes is shown in FIG. 3b.

The convergence property shown in FIG. 3b is appeared by the distortion of the red R and blue B pixels that should be positioned on the green G pixels, which caused in the course of the light spot displacement by the vertical deflection coil part. Table 1 shows errors between the green G and red R pixels, between the green G and blue B pixels, and between the red R and blue B pixels.

TABLE 1

(mm)

| | HR | VR | HR | VR | HR | VR | HR | VR | HR | VR |
|---|---|---|---|---|---|---|---|---|---|---|
| Error(G & R) | 0.00 | 0.09 | 0.03 | 0.04 | −0.03 | 0.06 | −0.01 | 0.14 | −0.11 | 0.32 |
| Error(G & B) | 0.34 | 0.31 | 0.20 | 0.18 | 0.12 | 0.06 | 0.06 | −0.02 | 0.17 | −0.07 |
| Error(B & R) | 0.33 | 0.22 | 0.17 | 0.14 | 0.14 | −0.01 | 0.07 | −0.16 | 0.28 | −0.39 |
| Error(G & R) | −0.12 | 0.23 | 0.00 | 0.03 | 0.03 | −0.01 | 0.07 | 0.02 | −0.05 | −0.04 |
| Error(G & B) | 0.26 | −0.03 | 0.11 | 0.03 | 0.11 | −0.01 | 0.13 | 0.00 | 0.27 | 0.12 |
| Error(B & R) | 0.38 | −0.26 | 0.11 | −0.00 | 0.08 | −0.00 | 0.05 | −0.01 | 0.31 | 0.16 |
| Error(G & R) | −0.11 | 0.07 | −0.04 | 0.02 | 0.00 | 0.00 | 0.06 | −0.02 | 0.07 | 0.08 |
| Error(G & B) | 0.21 | −0.01 | 0.10 | −0.02 | 0.00 | 0.00 | 0.16 | 0.01 | 0.25 | −0.02 |
| Error(B & R) | 0.32 | −0.09 | 0.13 | −0.04 | 0.00 | 0.00 | 0.10 | 0.03 | 0.17 | −0.10 |
| Error(G & R) | −0.12 | −0.05 | −0.00 | −0.01 | 0.07 | −0.04 | 0.07 | −0.11 | −0.14 | 0.02 |
| Error(G& B) | 0.23 | −0.06 | 0.10 | −0.06 | 0.11 | 0.01 | 0.15 | 0.04 | 0.30 | −0.06 |
| Error(B & R) | 0.36 | −0.01 | 0.10 | −0.06 | 0.04 | 0.05 | 0.08 | 0.15 | 0.43 | −0.08 |
| Error(G & R) | −0.00 | 0.10 | 0.05 | −0.00 | 0.05 | −0.13 | 0.00 | −0.26 | −0.04 | −0.40 |
| Error(G & B) | 0.16 | −0.28 | 0.19 | −0.16 | 0.13 | −0.05 | 0.07 | 0.12 | 0.19 | 0.16 |
| Error(B & R) | 0.16 | −0.38 | 0.14 | −0.16 | 0.08 | 0.08 | 0.07 | 0.38 | 0.23 | 0.56 |

(HR: Horizontal Error, VR: Vertical Error)

A distortion example with respect to the convergence property shown in FIG. 3b will be described with reference to Table 1.

Horizontal and vertical errors between the green G and red R pixels positioned on the point (x1, y1) are respectively −0.00 mm and 0.10 mm, horizontal and vertical errors between the green G and blue B pixels positioned on the point (x1, y1) are respectively −0.16 mm and −0.28 mm, and horizontal and vertical errors between the blue B and red R pixels with reference to the point (x1, y1) are respectively 0.16 mm and −0.38 mm.

Horizontal and vertical errors between the green G and red R pixels positioned on the point (x1, y5) are respectively 0.00 mm and 0.09 mm, horizontal and vertical errors between the green G and blue B pixels positioned on the point (x1, y5) are respectively 0.34 mm and 0.31 mm, and horizontal and vertical errors between the blue B and red R pixels with reference to the point (x1, y5) are respectively 0.33 mm and 0.22 mm.

Horizontal and vertical errors between the green G and red R pixels positioned on the point (x5, y1) are respectively −0.04 mm and −0.40 mm, horizontal and vertical errors between the green G and blue B pixels positioned on the point (x5, y1) are respectively 0.19 mm and 0.16 mm, and horizontal and vertical errors between the blue B and red R pixels with reference to the point (x5, y1) are respectively 0.23 mm and 0.56 mm.

Horizontal and vertical errors between the green G and red R pixels positioned on the point (x5, y5) are respectively −0.11 mm and 0.32 mm, horizontal and vertical errors between the green G and blue B pixels positioned on the point (x5, y5) are respectively 0.17 mm and −0.07 mm, and horizontal and vertical errors between the blue B and red R pixels with reference to the point (x5, y5) are respectively 0.28 mm and −0.39 mm.

As described above, as errors are incurred between the pixels by the vertical deflection coil part, as shown in FIG. 3a, a gap GA1 between the red R and blue B pixels at an upper, portion is widened and a gap GA2 between the red R and blue B pixels at a middle portion is also widened.

As described above, the wider the gap between the red R and blue B pixels, the more the definition of the image displayed on the monitor is deteriorated. To solve this problem, many techniques for correcting the misconvergence caused by the deflection yoke have been proposed. Japanese unexamined patent No. H8-154256 discloses one of such techniques.

As shown in FIG. 4, a misconvergence correcting apparatus 400 disclosed in the patent is formed on a portion of a vertical deflection coil part. FIG. 5 shows a sectional view of the misconvergence correcting apparatus 400.

As shown in the drawing, a circuit of the misconvergence correcting apparatus 400 has two loops LP3 and LP4.

The loop LP3 is comprised of coils L3 and L4, a resistor R3 and a diode D1.

The loop LP4 is comprised of the coils L3 and L4, a resistor R4 and a diode D2.

The coils L3 and L4 constituting a single circuit are, as shown in FIG. 5, symmetrically wound on a portion of the vertical deflection coil part.

That is, the deflection yoke comprises a pair of vertical deflection coils for displacing the light spot in a vertical direction and a pair of horizontal deflection coils for displacing the light spot in a horizontal direction. The vertical and horizontal deflection coils are symmetrically disposed at a predetermined interval by a separator.

As described above, the coils L1 and L2 defining the vertical deflection coil part are symmetrically formed with reference to the separator.

The coils L3 and L4 are disposed adjacent to coils L1 and L2, respectively, as shown in FIG. 5.

The operation of the above-described conventional deflection yoke will be described hereinafter.

In an initial state where the diodes D1 and D2 maintain an OFF state, when sawtooth current is applied, current flows along the coils L3 and L4. In this case, since a barrel magnetic field shown in FIG. 5 is formed extending to portions where the coils L3 and L4 are formed, the intensity of the barrel magnetic field is more enhanced.

Such an intensified barrel magnetic field pushes the light spot eradiated on the red R pixel to the blue B pixel, thereby correcting the misconvergence incurred on a middle portion of the monitor. As a result, as shown in FIG. 3, a gap GA2 between the red R and blue B pixels at the middle portion is reduced, the red R and blue B pixels are overlapped each other as shown in FIG. 3.

In a state where the current flows along the coils L3 and L4, when a predetermined amount of current is applied to the diodes D1 and D2, since the diodes D1 and D2 are short-circuited, the current being applied through the vertical deflection yoke is not directed toward the coils L3 and L4 but to the short-circuited diodes D1 and D2.

When the input current does not flow along the L3 and L4, as shown in FIG. 5, the barrel magnetic field is not formed on around the coils L3 and L4 but only around the vertical deflection coils L1 and L2. As a result, since the barrel magnetic field is generated only by the vertical deflection coils, a pinned barrel magnetic field is formed. Therefore, force F for pushing the light spot eradiated on the red R pixel upward is weaken, causing the light spot eradiated on the red R pixel to move downward to the blue B pixel to thereby correct the misconvergence generated at the upper portion of the monitor. As a result, a gap GA1 between the red R and blue B pixels at the upper portion is reduced as shown in FIG. 6.

After the misconvergence at the upper portion is corrected, when the diodes D1 and D2 is turned off, the input current flows along the L3 and L4 to form the barrel magnetic field again, thereby correcting the misconvergence generated at the middle portion of the monitor.

In this state, when the diodes D1 and D2 are turned on, the current flow to the coils L3 and L4 is cut off to form the weak barrel magnetic field, thereby correcting again the misconvergence generated at the upper portion of the monitor.

As described above, the conventionally convergence correcting apparatus is designed such that the diodes D1 and D2 function as a switch to control the current flow applied to the correcting coils L3 and L4.

When the diodes D1 and D2 are turned on with the current flowing along the correcting coils L3 and L4, the current flow to the correcting coils L3 and L4 are abruptly cut off in a moment. When the diodes D1 and D2 are turned off, the current abruptly flows along the correcting coils L3 and L4.

The abruption current change causes a noise and a discontinuous pixel variation, thereby deteriorating the definition of the image displayed on the monitor.

### SUMMARY OF THE INVENTION

Accordingly, the present invention is directed to a deflection yoke that substantially obviate one or more problems due to limitations and disadvantages of the related art.

A first object of the present invention is to provide a deflection yoke that can compensate for a magnetic field using two pairs of correcting coils symmetrically wound in an opposite direction around a portion of a vertical deflection coil part to weaken a barrel magnetic field, thereby forming a pinned magnetic field.

A second object of the present invention is to provide a deflection yoke that can correct a misconvergence by compensating for magnetic field in a state where current keeps flowing along two pairs of correcting coils symmetrically wound in an opposite direction around a portion of a vertical deflection coil part.

A third object of the present invention is to provide a deflection yoke that can linearly displace a red beam toward a blue beam by correcting a misconvergence in a state where current keeps flowing along two pairs of correcting coils symmetrically wound in an opposite direction around a portion of a vertical deflection coil part.

A fourth object of the present invention is to provide a deflection yoke that minimize the noise generation by linearly displacing a red beam in the course of correcting the misconvergence by a vertical deflection coil part.

To achieve the above objects, the present invention provides a deflection yoke comprising a vertical deflection coil part for deflecting light spot eradiated on a screen by generating a barrel magnetic field using sawtooth current inputted from an external power source; and misconvergence correcting means for enhancing intensity of the barrel magnetic field by generating a first magnetic field using the sawtooth current to correct misconvergence incurred when the light spot eradiated on a middle portion of the screen is deflected and for weakening the barrel magnetic field by generating a second magnetic field opposite to the first magnetic field to correct misconvergence incurred when the light spot eradiated on an upper portion of the screen is deflected.

According to another aspect of the present invention, there is provided a deflection yoke comprising a first correcting part for generating a first magnetic field using the sawtooth current to enhance the intensity of a barrel magnetic field for correcting misconvergence generated when light spot eradiated on a middle portion of a screen is deflected; a second correcting part for generating a second magnetic field opposite to the first magnetic field compensating for the first magnetic field to weaken the intensity of the barrel magnetic field for correcting misconvergence generated when light spot eradiated on an upper portion of the screen is deflected, and a current flow control part for controlling the current flow of the second correcting part, the current flow control part being turned on and off by the current inputted from the external power source.

According to still another aspect of the present invention, there is provided a deflection yoke comprising a first loop for generating a magnetic field using sawtooth current inputted from an external power source, the first loop being comprised of first to fourth coils and a first diode; and a second loop comprised of the first diode and a second diode, wherein the first and second coils are connected to each other in a series, and the third and fourth coils are connected to each other in a series but are connected to the first and second coils in parallel; the first diode has an anode connected to one end of the second coil and a cathode commonly connected to one end of the fourth coil and an anode of the second diode; and the second diode has an anode commonly connected to one end of the second coil and the cathode of the first diode, and a cathode commonly connected to one end of the fourth coil and the anode of the first diode.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a circuit diagram illustrating a vertical deflection coil part of a conventional deflection yoke;

FIG. 2 is a sectional view of a vertical deflection coil part of a conventional deflection yoke;

FIG. 3a is an example view of a light spot displaced by a conventional vertical deflection coil part;

FIG. 3b is a view illustrating a convergence property of a conventional vertical deflection coil part;

FIG. 4 is a circuit diagram of a conventional deflection yoke for correcting a misconvergence;

FIG. 5 is a sectional view of a conventional deflection yoke for correcting a misconvergence;

FIG. 6 is an example view, illustrating a misconvergence correcting process of a conventional deflection yoke;

FIG. 7 is a side view of a cathode ray tube where a deflection yoke according to the present invention is employed;

FIG. 8 is a front view of a deflection yoke according to a preferred embodiment of the present invention;

FIG. 9 is a circuit diagram of a deflection yoke according to a preferred embodiment of the present invention;

FIG. 10 is a sectional view of a deflection yoke according to a preferred embodiment of the present invention;

FIGS. 11a and 11b are example views illustrating a misconvergence correcting process of a deflection yoke according to a preferred embodiment of the present invention; and

FIG. 12 is a view illustrating a convergence property of a deflection yoke according to a preferred embodiment of the present invention.

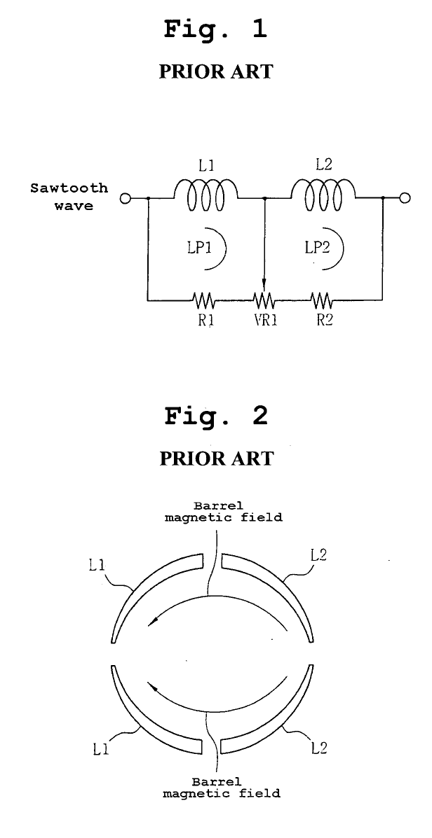

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

The present invention is directed to a vertical deflection coil part of a deflection yoke for a CRT. Such a deflection yoke is provided in order for image signals transmitted by time series to be regenerated as an image on a screen of the CRT. That is, the deflection yoke is designed to accurately deflect three color electron beams emitted from an electron gun toward a phosphor layer deposited on the screen by allowing the electron beams to pass through a magnetic field formed by horizontal and vertical deflection coil parts.

The deflection yoke successively moves the electron beams emitted from the electron gun in vertical and horizontal directions to regenerate the image. FIG. 7 shows a CRT having such a deflection yoke.

FIG. 7 shows a CRT having a deflection yoke of the present invention.

As shown in the drawing, a deflection yoke 100 is installed around an RGB electron gun part 300 of a CRT 200 to deflect electron beams emitted from an electron gun 310 toward a phosphor layer deposited on a screen surface 210.

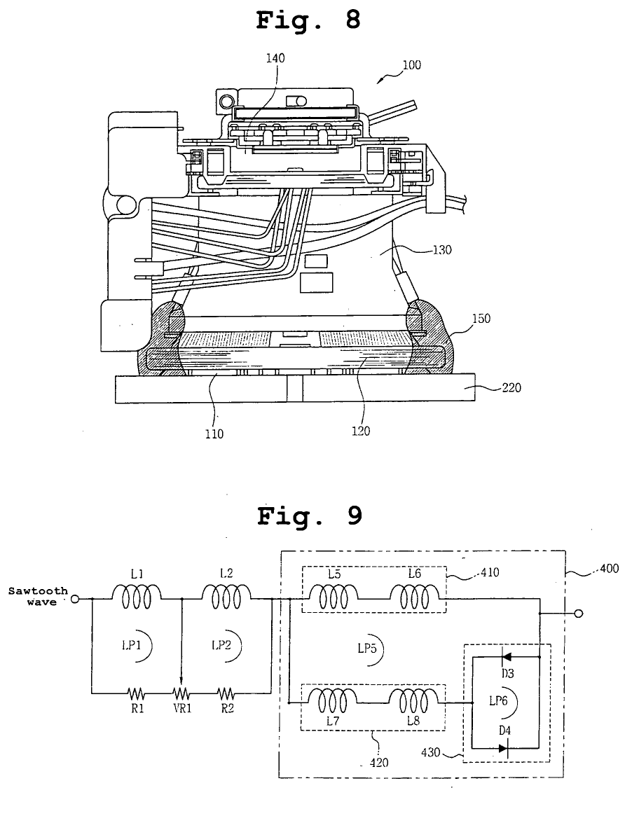

FIG. 8 schematically shows a front view of the deflection yoke according to a preferred embodiment of the present invention.

The inventive deflection yoke 100 includes a coil separator 110, horizontal and vertical deflection coil parts (only the vertical deflection coil part 120 is shown in the drawing) disposed on inner and outer circumferences of the coil separator to form horizontal and vertical deflection magnetic fields, respectively, and a ferrite core for enhancing the magnetic fields formed by the horizontal and vertical deflection coil parts.

The coil separator 110 is formed in a conical-shape, comprising a screen part 200 facing the screen surface 210 of the CRT 200 and a cylindrical neck part 140 coupled around the electron gun part 300. The screen part 200 and the neck part 140 are integrally connected to each other by a connecting part formed in a trumpet-shape.

The horizontal deflection coil part is divided into upper and lower parts that are assembled on the inner circumference of the coil separator 110. The vertical deflection coil part 120 is divided into left and right parts that are assembled on the outer circumference of the coil separator 110.

That is, the horizontal deflection coil part is disposed closely contacting the inner circumference of the coil separator 110 to form the horizontal deflection magnetic field. That is, the vertical deflection coil part 120 is disposed closely contacting the outer circumference of the coil separator 110 to form the vertical deflection magnetic field.

Here, each of the horizontal and vertical parts 120 are formed of a pair of coil sections that are manufactured in a separated production line and assembled on the coil separator 110.

Likewise, misconvergence-correcting coils are symmetrically wound around portions of the pair of coil sections of the vertical deflection coil part 120 in the course of manufacturing the pair of vertical deflection coil parts 120.

The ferrite core 130 is formed on a pair of sections defining the cylindrical shape, which are assembled on the outer circumference of the coil separator 110 to enclose the vertical deflection coil parts 120, thereby enhancing the vertical deflection magnetic field.

The vertical deflection coil part 120 may be firmly fixed on the coil separator 110 by a thermal adhesive 150 preventing the vertical deflection coil part 120 from moving by outer impact. The adhesive 150 is applied along a peripheral contacting portion between the vertical deflection coil part 120 and the coil separator 110.

That is, when the vertical deflection coil part 120 deviates from a concentric position by the outer impact, there may be an intensity difference between left and right sections of the magnetic field, causing misconvergence and geometric distortion (G/D). In order to prevent this, the vertical deflection coil part 120 is fixed by the adhesive 150.

As described above, misconvergence-correcting coils are wound around a portion of the vertical deflection coil part 120, and are then stably fixed on the deflection yoke 100. However, the assembling method of the vertical deflection coil part 120 is not limited to this.

For example, the vertical deflection coil part 120 can be stably fixed on the coil separator 110 by a fixing member without using the thermal adhesive 150.

FIG. 9 shows a circuit diagram of the deflection yoke for correcting the misconvergence.

As shown in the drawing, a misconvergence correcting apparatus 400 is formed on a portion of the vertical deflection coil part 120. Here, the vertical deflection coil part 120 includes loops LP1 and LP2. The loop LP1 is comprised of a coil L1, a variable resistor VR1 and a resistor R1, and the loop LP2 is comprised of a coil L2, the variable resistor VR1 and a resistor R2.

The misconvergence correcting apparatus 400 includes a first correcting part 410 for generating a first magnetic field using external sawtooth current to enhance the intensity of a barrel magnetic field for correcting misconvergence generated when the light spot eradiated on a middle portion of the screen is deflected, a second correcting part 420 for compensating for the first magnetic field generated by the first correcting part 410 by generating a second magnetic field opposite to the first magnetic field to weaken the intensity of the barrel magnetic field for correcting the misconvergence generated when the light spot eradiated on the upper portion of the screen, and a current flow control part 430 for controlling the current flow of the second correcting part 420, the current flow control part 430 being turned on and off by external current inputted.

The first correcting part 410 is comprised of two coils L5 and L6 that are connected to each other in a series.

The second correcting part 420 is comprised of two coils L7 and L8 that are connected to each other in a series.

The current flow control part 430 is comprised of a diode D3 having an anode (+) connected to the coil L6 and a cathode (−) connected to the coil L8, and a diode D4 having an anode commonly connected to the cathode of the diode D3 and the coil L8, and a cathode commonly connected to the coil L6 and the anode of the diode D3.

The circuit connection of the misconvergence correcting apparatus provided in the inventive deflection yoke will be described more in detail hereinafter.

As shown in the drawing, the misconvergence correcting apparatus 400 is comprised of two loops LP5 and LP6.

The loop LP5 is comprised of the coils L5 and L6, the L7 and L8 that are connected to the coils L5 and L6 in parallel, and the diode D3.

The loop LP6 is comprised of the diodes D3 and D4.

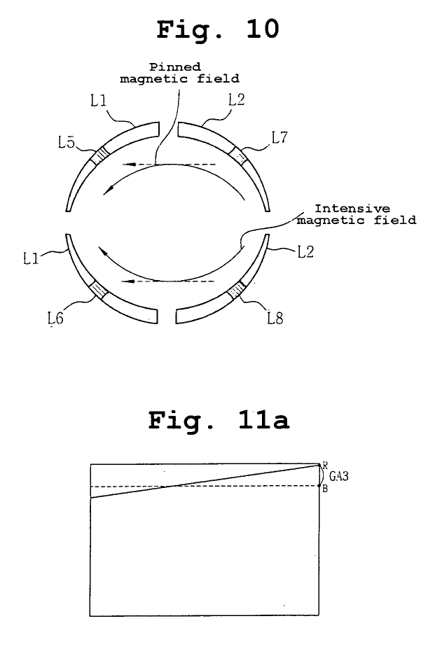

The coils L5 and L8 constituting the single circuit are, as shown in FIG. 10, symmetrically wound around the vertical deflection coil part. This will be described more in detail hereinafter.

The coils L1 and L2 defining the vertical deflection coil part are symmetrically disposed with reference to the coil separator. The coils L5 and L6 are wound around a middle portion of the coil L1 at a predetermined interval.

Referring to FIG. 10, the coils L7 and L8 are also wound around a middle portion of the coil L2 at a predetermined interval.

Here, winding directions of the coils L5 and L6 are identical to each other, and winding directions of the coils L7 and L8 are identical to each other but opposite to those of the coils L5 and L6. Each coil is formed of more than two bundles.

The number of turns of the coils L5 and L8 are identical to each other.

Although the misconvergence-correcting coils L5 to L8 are wound on the middle portions of the coils defining the vertical deflection coil part, the present invention is not limited to this.

The operation of the deflection yoke for correcting the misconvergence according to the present invention will be described more in detail hereinafter.

In an initial state where the diodes D1 and D2 maintain an Off state, when external sawtooth current is applied, the coils L1 and L2 defining the vertical deflection coil part form a barrel magnetic field to vertically displace the light spot eradiated on the screen.

At this point, since the diodes D1 and D2 maintain the off state, the external sawtooth current flows only along the coils L5 and L6. Therefore, the coils L5 and L6 form the barrel magnetic field as shown in FIG. 10. The barrel magnetic field corrects the misconvergence generated at the middle portion of the screen. That is, the barrel magnetic field pushes the light spot eradiated on the red R pixel upward to the blue B pixel, thereby correcting the misconvergence incurred at the middle portion of the monitor.

In a state where the current flows along the coils L5 and L6, when a predetermined amount of current is applied to the diodes D3 and D4, the diodes D3 and D4 are short-circuited.

As a result, the inputted sawtooth current flows along the correcting coils L5 and L6 as well as the correcting coils L7 and L8 symmetrical to the correcting coils L5 and 6. This will be described more in detail hereinafter.

The diode D3 is turned on by negative current of the tooth current, while the diode D4 is turned on by positive current of the tooth current.

When the negative current is applied, since only the diode D3 is turned on, the current flow to the coils L7 and L8 is cut off by the diode D4. As a result, the input current flows to only the coils L5 and L6.

At this point, the coils L5 and L6 generate an enhanced magnetic field when the sawtooth current is inputted thereto. The magnetic field generated by the coils L5 and L6 is higher than the barrel magnetic field generated by the vertical deflection coil part, thereby correcting the misconvergence incurred at the middle portion of the screen.

The reason why there is need for the enhanced magnetic field to correct the misconvergence incurred at the middle portion of the screen is to move the light spot eradiated on the red R pixel upward to the blue B pixel. Describing more in detail, force F for moving the light spot eradiated on the red R pixel upward is determined by current I and a magnetic field B in accordance with Fleming's left-hand rule. Therefore, the higher the intensity of the magnetic field B, the higher the force F. That is, by enhancing the intensity of the magnetic field B, the light spot eradiated on the red R pixel can be accurately displaced to the blue B pixel, improving the definition of the middle portion of the screen.

Meanwhile, since the coils L5 and L6 define a single loop that is connected to the power source without going through the diode D3. That is, the coils L5 and L6 can generate the magnetic file using the sawtooth current applied from the power source with the diode D3 being not turned on.

In a state where the current flows along the coils L5 and L6, when the positive current of the sawtooth current is applied, current flow to the coils L7 and L8 is realized due to the diode D turned on.

When such current flow is realized, the coils L7 and L8 generate the magnetic field by the inputted sawtooth current. At this point, since a direction of this magnetic field generated by the coils L7 and L8 is opposite to that of the magnetic field generated by the coils L5 and L6, the magnetic field generated by the coils L7 and L8 compensate fors the magnetic field generated by the coils L5 and L6. That is, since the coils L5 and L6 are wound in an opposite direction to the coils L7 and L8, the magnetic fields are opposite to each other.

As the magnetic fields generated by the coils L5 to L8 are compensated for each other, as shown in FIG. 10, the intensive barrel magnetic field is changed into a pinned magnetic field as shown in FIG. 10. In the present invention, since the coils L5 and L8 are wound around the middle portion of the vertical deflection coil part, the barrel magnetic fields generated on a portion corresponding to the middle portion of the vertical deflection coil part are compensated for each other and the more pinned magnetic field can be obtained as shown in FIG. 10.

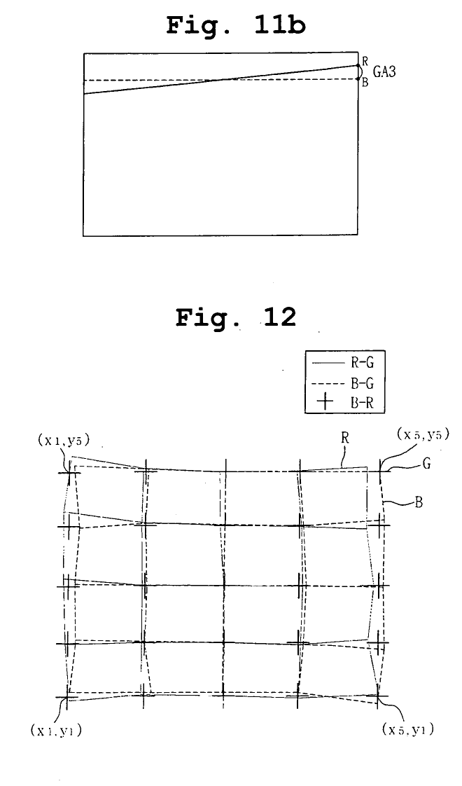

At this point, the pinned magnetic field corrects the misconvergence incurred at the upper portion of the screen as shown in FIGS. 11a and 11b.

In order to correct the misconvergence incurred at the upper portion of the screen, the force F for deflecting the light spot eradiated on the red R pixel should be weakened to displace the light spot eradiated on the red R pixel downward to the blue B pixel. Accordingly, in the present invention, the correcting coils L5 and L8 are wound around the middle portion of the vertical deflection yoke to compensate for the magnetic fields generated at the portions where the coils L5 and L8 are wound. As a result, the pinned magnetic field that is weaker than the barrel magnetic field is generated. That is, as the intensity of the barrel magnetic field is weakened, the force F for moving the light spot is weakened according to Fleming's left-hand rule. As a result, the light spot eradiated on the red R pixel formed on the upper portion of the screen is not displaced upward but displaced toward the blue B pixel.

As described above, by correcting the misconvergence incurred at the upper portion of the screen, the definition of the screen can be improved.

In addition, since the current flowing along the L5 and L6 is not cut off even in the course of correcting the misconvergence incurred at the upper portion of the screen, the red beam is linearly varied as the current flow is not changed in a moment, thereby reducing the noise generation as compared with the prior art.

The above-described deflection yoke of the present invention has a convergence property as shown in FIG. 12.

Referring to FIG. 12, there is shown a convergence property of the red R and blue B pixels that are distorted with reference to the green G pixel.

As shown in FIG. 12, the green G pixels are arranged on X and Y-axes at a predetermined interval. Describing more in detail, five green G pixels are positioned on points x1-x5 that are arranged in a direction of the X-axis at a predetermined interval. Five green G pixels are further positioned in a direction of the Y-axis at a predetermined interval.

For example, a green G pixel is position on a point (x1, y1), a green G pixel is located on a point (x1, y5), a green G pixel is position on a point (x5, y1), and a green G pixel is located on a point (x5, y5). At this point, distances between the points are identical to each other.

As described above, a distortion property of the red R and blue B pixels with reference to the green G pixels arranged on the X and Y-axes is shown in FIG. 12.

The convergence property shown in FIG. 12 is appeared by the distortion of the red R and blue B pixels that should be positioned on the green G pixels, which caused in the course of the light spot displacement by the vertical deflection coil part. Table 2 shows errors between the green G and red R pixels, between the green G and blue B pixels, and between the red R and blue B pixels.

TABLE 2

(mm)

| | HR | VR | HR | VR | HR | VR | HR | VR | HR | VR |
|---|---|---|---|---|---|---|---|---|---|---|
| Error(G & R) | 0.03 | 0.26 | −0.03 | 0.06 | −0.11 | 0.00 | −0.11 | 0.03 | −0.17 | 0.12 |
| Error(G & B) | 0.06 | 0.11 | 0.05 | 0.03 | 0.04 | −0.00 | −0.02 | 0.01 | 0.08 | 0.02 |
| Error(B & R) | 0.03 | −0.16 | 0.09 | −0.02 | 0.15 | −0.00 | 0.09 | −0.03 | 0.25 | −0.10 |
| Error(G & R) | −0.16 | 0.24 | −0.08 | 0.04 | −0.04 | −0.01 | −0.03 | 0.01 | −0.16 | −0.05 |
| Error(G & B) | 0.15 | −0.06 | 0.01 | 0.03 | −0.00 | −0.02 | 0.04 | 0.00 | 0.19 | 0.15 |
| Error(B & R) | 0.31 | −0.30 | 0.19 | −0.02 | 0.04 | −0.01 | 0.06 | −0.01 | 0.35 | 0.20 |
| Error(G & R) | −0.14 | 0.09 | −0.07 | 0.04 | 0.00 | 0.00 | 0.01 | −0.01 | −0.02 | 0.08 |
| Error(G & B) | 0.10 | −0.01 | 0.04 | −0.01 | 0.00 | 0.00 | 0.09 | 0.02 | 0.17 | 0.00 |
| Error(B & R) | 0.24 | −0.10 | 0.10 | −0.05 | 0.00 | 0.00 | 0.08 | 0.03 | 0.19 | −0.08 |
| Error(G & R) | −0.10 | 0.07 | −0.04 | 0.02 | 0.04 | −0.02 | 0.05 | −0.05 | −0.14 | 0.10 |
| Error(G & B) | 0.11 | −0.00 | 0.00 | −0.01 | 0.01 | 0.01 | 0.04 | 0.02 | 0.20 | −0.10 |
| Error(B & R) | 0.21 | 0.06 | 0.04 | −0.03 | −0.04 | 0.03 | −0.01 | 0.07 | 0.34 | −0.20 |
| Error(G & R) | −0.02 | −0.10 | −0.05 | 0.01 | −0.02 | 0.00 | −0.02 | 0.03 | 0.10 | 0.07 |
| Error(G & B) | −0.04 | −0.09 | 0.15 | 0.10 | 0.02 | 0.11 | 0.01 | 0.06 | 0.09 | −0.07 |
| Error(B & R) | −0.01 | −0.19 | 0.20 | 0.09 | 0.04 | 0.10 | 0.03 | 0.03 | −0.01 | −0.15 |

(HR: Horizontal Error, VR: Vertical Error)

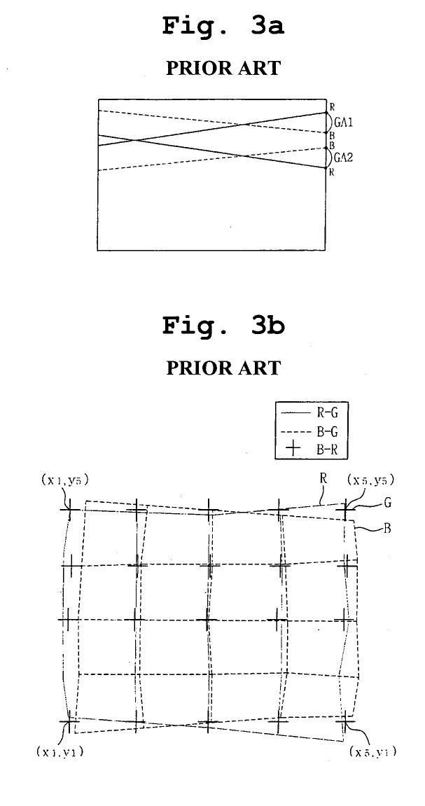

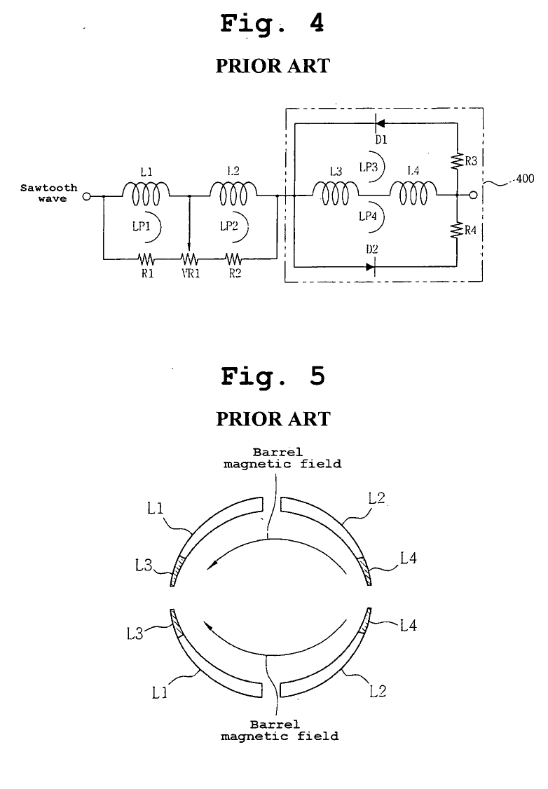

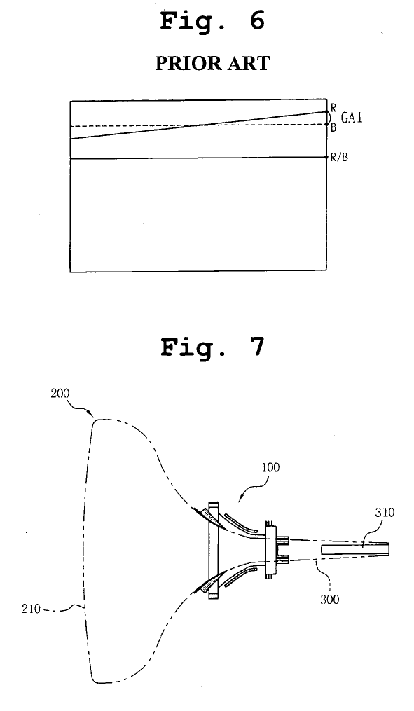

A distortion example with respect to the convergence property shown in FIG. 3b will be described with reference to Table 1.

Horizontal and vertical errors between the green G and red R pixels positioned on the point (x1, y1) are respectively −0.02 mm and 0.10 mm, horizontal and vertical errors between the green G and blue B pixels positioned on the point (x1, y1) are respectively −0.04 mm and −0.09 mm, and horizontal and vertical errors between the blue B and red R pixels with reference to the point (x1, y1) are respectively −0.01 mm and 0.19 mm.

Horizontal and vertical errors between the green G and red R pixels positioned on the point (x1, y5) are respectively 0.03 mm and 0.26 mm, horizontal and vertical errors between the green G and blue B pixels positioned on the point (x1, y5) are respectively 0.06 mm and 0.11 mm, and horizontal and vertical errors between the blue B and red R pixels with reference to the point (x1, y5) are respectively 0.03 mm and −0.16 mm.

Horizontal and vertical errors between the green G and red R pixels positioned on the point (x5, y1) are respectively 0.10 mm and 0.07 mm, horizontal and vertical errors between the green G and blue B pixels positioned on the point (x5, y1) are respectively 0.09 mm and −0.07 mm, and horizontal and vertical errors between the blue B and red R pixels with reference to the point (x5, y1) are respectively −0.01 mm and −0.15 mm.

Horizontal and vertical errors between the green G and red R pixels positioned on the point (x5, y5) are respectively −0.17 mm and 0.12 mm, horizontal and vertical errors between the green G and blue B pixels positioned on the point (x5, y5) are respectively 0.08 mm and 0.02 mm, and horizontal and vertical errors between the blue B and red R pixels with reference to the point (x5, y5) are respectively 0.25 mm and −0.10 mm.

When the misconvergence is corrected by the inventive deflection yoke, as shown in Tables 1 and 2, the horizontal and vertical errors between the blue B and red R pixels according to the convergence property of the inventive deflection yoke can be remarkably reduced as compared with those according to the convergence property of the prior deflection yoke.

As described above, as the misconvergence is corrected by compensating for the magnetic fields in a state where current keeps flowing along first and second pairs of correcting coils that are symmetrically wound around the vertical deflection coil part in an opposite direction to each other, the red beam is linearly varied, thereby minimizing the noise generation and remarkably improving the definition of the screen.

It will be apparent to those skilled in the art that various modifications and variations can be made in the present invention. Thus, it is intended that the present invention covers the modifications and variations of this invention provided they come within the scope of the appended claims and their equivalents.

1. A deflection yoke comprising:
a vertical deflection coil part for generating a barrel magnetic field using a sawtooth current inputted from an external power source to deflect light spot eradiated on a display screen; and
misconvergence correcting means for generating a first magnetic field using the sawtooth current so as to enhance intensity of the barrel magnetic field to correct misconvergence incurred when the light spot eradiated on a middle portion of the screen is deflected and for generating a second magnetic field opposite to the first magnetic field at a predetermined portion of the vertical deflection coil and compensating for the first magnetic field and the second magnetic field so as to change the barrel magnetic field to a pinned magnetic field, the barrel magnetic field correcting misconvergence incurred when the light spot eradiated on an upper portion of the screen.

2. The deflection yoke of claim 2, wherein the misconvergence correcting means comprises:
a first correcting part for generating the first magnetic field using the sawtooth current so as to enhance intensity of the barrel magnetic field to correct the misconvergence incurred when the light spot eradiated on a middle portion of the screen is deflected;
a second correcting part for generating the second magnetic field opposite to the first magnetic field generated at the first correcting part and compensating for the first magnetic field and the second magnetic field so as to change the barrel magnetic field to the pinned magnetic field, the barrel magnetic field correcting misconvergence incurred when the light spot eradiated on an upper portion of the screen; and
a current flow control part for controlling the current flow of the second correcting part, the current flow control part being turned on and off by the current inputted from the external power source.

3. A deflection yoke comprising:
a first correcting part for generating a first magnetic field using a sawtooth current inputted from an external power source so as to enhance intensity of a first barrel magnetic field correcting a first misconvergence generated when light spot eradiated on a middle portion of a screen is deflected;
a second correcting part for generating a second magnetic field opposite to the first magnetic field generated at the first correcting part using the sawtooth current and compensating for the first magnetic field and the second magnetic field so as to change a second barrel magnetic field to a weakened pinned magnetic field, the second barrel magnetic field correcting a second misconvergence generated when light spot eradiated on an upper portion of the screen is deflected, and
a current flow control part for controlling the current flow of the second correcting part, the current flow control part being turned on and off by the current inputted from the external power source.

4. The deflection yoke of one of claims 3, wherein the first correcting part comprises first and second coils that are connected to each other in a series.

5. The deflection yoke of claim 4, wherein the second correcting part comprises third and fourth coils that are connected to each other in a series.

6. The deflection yoke of claim 5, wherein the current flow control part comprises first and second diodes defining a single loop.

7. The deflection yoke of claim 5, wherein the first and second coils are connected to the third and fourth coils in parallel.

8. The deflection yoke of claim 7, wherein the first to fourth coils have an identical number of turns.

9. The deflection yoke of claim 7, wherein winding directions of the first and second coils are opposite to those of the third and fourth coils.

10. The deflection yoke of claim 7, wherein each of the first to fourth coils has more than two bundles.

11. The deflection yoke of claim 6, wherein the first to fourth coils and the first diode define a single loop.

12. The deflection yoke of claim 11, wherein in an initial state for correcting the misconvergence, the sawtooth current flows along the first and second coils.

13. The deflection yoke of claim 11, wherein the first diode has an anode connected to one end of the second coil and a cathode commonly connected to one end of the fourth coil and an anode of the second diode.

14. The deflection yoke of claim 13, wherein the first diode is turned on by negative current of the sawtooth current to allow the current to flow along the first and second coils.

15. The deflection yoke of claim 13, wherein the second diode has an anode commonly connected to one end of the second coil and the cathode of the first diode, and a cathode commonly connected to one end of the fourth coil and the anode of the first diode.

16. The deflection yoke of claim 15, wherein the second diode is turned on by positive current of the sawtooth current to allow the current to flow along the third and fourth coils.

17. The deflection yoke of claim 16, wherein a direction of the magnetic field generated by the third and fourth coils is opposite to that of the magnetic field generated by the first and second coils.

18. A deflection yoke comprising:
a first loop for generating a magnetic field using sawtooth current inputted from an external power source, the first loop being comprised of first to fourth coils and a first diode; and
a second loop comprised of the first diode and a second diode,
wherein the first and second coils are connected to each other in a series, and the third and fourth coils are connected to each other in a series but are connected to the first and second coils in parallel;
the first diode has an anode connected to one end of the second coil, and a cathode commonly connected to one end of the fourth coil and an anode of the second diode; and
the second diode has an anode commonly connected to one end of the second coil and the cathode of the first diode, and a cathode commonly connected to one end of the fourth coil and the anode of the first diode.
